(19) United States
(12) Patent Application Publication
(10) Pub. No.: US 2026/0045880 A1
(43) Pub. Date: Feb. 12, 2026

(54) OVER-VOLTAGE PROTECTION IN FLYBACK POWER CONVERTERS

(71) Applicant: Texas Instruments Incorporated, Dallas, TX (US)

(72) Inventors: Prathamesh Pilankar, Bangalore (IN); Suvadip Banerjee, Bangalore (IN); Michael Lueders, Freising (DE); Ramkumar Sivakumar, Bangalore (IN); Akhila Gundavarapu, Bangalore (IN); Stefan Herzer, Freising (DE)

(21) Appl. No.: 19/192,900

(22) Filed: Apr. 29, 2025

(30) Foreign Application Priority Data
Aug. 6, 2024 (IN) 202441059286

(51) Int. Cl. H02M 3/335; H02M 1/00; H02M 1/32; H02M 1/44

(52) U.S. Cl. CPC H02M 3/33523; H02M 1/0029; H02M 1/32; H02M 1/44

(57) ABSTRACT

Techniques for valley detection in flyback power converters. In an example, circuitry implementing the techniques is configured to generate a first indication of an over-voltage protection (OVP) condition of a flyback power converter, using a switching terminal signal of the flyback power converter. The circuitry is further configured to generate a second indication of an input voltage surge condition of the flyback power converter, using the switching terminal signal of the flyback power converter. The circuitry further is further configured to suppress the first indication, responsive to the second indication being generated.

### CROSS-REFERENCE TO RELATED APPLICATION

This application claims the benefit of and priority to India (IN) Provisional Patent Application No. 202441059286 filed on Aug. 6, 2024, which is incorporated herein by reference in its entirety.

### TECHNICAL FIELD

This description relates to power converters, and in particular, to over-voltage protection in flyback power converters.

### BACKGROUND

A flyback power converter is a switch mode power supply that converts an AC or DC input voltage to one or more regulated DC output voltages. A flyback converter topology generally includes in input capacitor, a primary-side switching element (e.g., metal oxide semiconductor field effect transistor, or MOSFET), a coupled inductor called a flyback transformer, an output diode or rectifier, and an output capacitor. The transformer allows for energy storage, energy transfer, and galvanic isolation between the input and any outputs. The turns ratio between the primary and secondary windings of the transformer can be set to enable the output voltage to be lower or higher than the input voltage. In operation, when the primary-side switching element is closed (on-time, or TON), the primary winding of the transformer is connected to the input voltage and the primary-side current ramps up, thus storing energy in the gap or core of the transformer. During this on-time, the output diode is reverse-biased and off, and the output capacitor supplies the load current. When the primary-side switching element is open (off-time, or TOFF), the current in the transformer transfers to the secondary and flows through the output diode that is now forward-biased, thereby replenishing the output capacitor and supplying the load current. During this process, the secondary-side current ramps down as the transformer core demagnetizes. Some flyback converters use an auxiliary transformer winding for valley sensing and over-voltage-protection, and to generate a low-voltage bias supply. A number of non-trivial issues remain with flyback power converters.

### SUMMARY

In an example, a circuit includes: a first comparator configured to generate a first indication of an over-voltage protection (OVP) condition of a flyback power converter, using a switching terminal signal of the flyback power converter; a second comparator configured to generate a second indication of an input voltage surge condition of the flyback power converter, using the switching terminal signal of the flyback power converter; and a logic circuit configured to suppress the first indication from the first comparator, responsive to the second indication from the second comparator.

In another example, a circuit includes: a first circuit configured to scale a switching terminal signal of a flyback power converter by a scaling factor, so as to generate a scaled version of the switching terminal signal; a second circuit configured to determine a running average input voltage of the flyback power converter based on the scaled version of the switching terminal signal; and a third circuit configured to use the running average input voltage to determine if both an over-voltage protection (OVP) condition and an input voltage surge condition are present in the flyback power converter, and suppress an indication of the OVP condition responsive to the input voltage surge condition being present.

In another example, a method includes: comparing VIN+N*VOUT to VIN(AVG)+N*VREF, wherein VIN corresponds to an input voltage of a flyback power converter, VIN(AVG) corresponds to a running average input voltage of the flyback power converter, N corresponds to a turns ratio of the flyback power converter, VOUT corresponds to an output voltage of the flyback power converter, and VREF corresponds to a voltage limit of the flyback power converter; and responsive to VIN+N*VOUT being greater than VIN(AVG)+N*VREF, comparing VIN(AVG) to a sample of the running average input voltage adjusted by a voltage; responsive to VIN(AVG) being greater than the sample of the running average input voltage adjusted by the voltage, indicating an input voltage surge condition; and responsive to VIN(AVG) not being greater than the sample of the running average input voltage adjusted by the voltage, indicating an over-voltage protection condition.

### BRIEF DESCRIPTION OF THE DRAWINGS

FIG. 1 illustrates a block diagram of a flyback power converter system configured with an over-voltage protection (OVP) circuit, in an example.

FIG. 2 illustrates an example signal of a switching terminal of a flyback power converter.

FIG. 3 illustrates a block diagram of the OVP circuit of the system of FIG. 1, in an example.

FIG. 4A illustrates a schematic diagram of the OVP circuit of the system of FIGS. 1 and 3, in an example.

FIG. 4B illustrates a schematic diagram of the VIN(AVG) processing circuit of the OVP circuit of FIG. 4A, in an example.

FIG. 4C illustrates a schematic diagram of the delay circuit of the OVP circuit of FIG. 4A, in an example.

FIG. 4D illustrates a schematic diagram of the leakage ringing filter circuit of the OVP circuit of FIG. 4A, in an example.

FIGS. 5A and 5B each illustrates plots of signals generated by the system of FIG. 1, in an example.

FIG. 6 illustrates a flow chart of a method for over-voltage protection in a flyback power converter, in an example.

FIG. 7 illustrates a block diagram of a system including a flyback power converter configured for over-voltage protection without using an auxiliary winding, in an example.

### DETAILED DESCRIPTION

Techniques are described herein for over-voltage protection in flyback power converters. The techniques allow a power converter to detect an over-voltage condition using the signal at the switching node or terminal of a flyback power converter, and can be implemented without an auxiliary transformer winding. The techniques further allow over-voltage conditions to be distinguished from input voltage surge conditions, which may cause a false indication of an over-voltage condition. In an example, circuitry implementing the techniques is configured to both detect a running average of the flyback power converter's input voltage, and compare that running average input voltage to a sample of the average input voltage adjusted to reflect a surge condition. The sample adjusted to reflect a surge condition effectively represents a surge condition reference level, and can be taken, for instance, when an over-voltage condition is detected by the circuitry. In an example case, if the running average input voltage is greater than the surge condition reference level, then an input voltage surge condition can be indicated, while indication of the over-voltage condition is temporarily suppressed, to allow the input voltage surge condition to either be confirmed or subside. If the surge condition subsides, the related but false OVP indication will also subside. The duration of the surge condition checking period may be inversely proportional to the running average input voltage (e.g., 40 μs for input voltage of 400 volts, and 120 μs for input voltage of 60 volts). The techniques and circuitry thus allow high confidence surge-aware declarations of over-voltage conditions.

### General Overview

As described above, a number of non-trivial issues remain with flyback power converters. In more detail, existing flyback power converter topologies use an auxiliary winding of the flyback transformer to facilitate functions such as sensing over-voltage conditions. Such aux-based sensing may further necessitate additional discrete components (e.g., high voltage linear regulator) and a separate package pin. The auxiliary winding, additional discrete components and pin increase overall cost and footprint of the converter. Thus, eliminating the auxiliary winding, additional discrete components and pin would be beneficial. However, doing so gives rise to the need for a new way to perform over-voltage protection. One possible approach is to use the signal at the switching terminal of the flyback power converter, to detect over-voltage conditions. To detect an over-voltage condition from the switching terminal signal, the value for each of the input voltage, the output voltage, and the flyback transformer turns ratio are needed. Also, while input voltage surge does not translate to an auxiliary winding, it does manifest on the switching terminal signal. The sudden rise on the input voltage attributable to a surge condition can cause a false indication of an over-voltage condition. As such, a given aux-less approach to over-voltage protection should be surge-aware.

Accordingly, techniques are described herein for providing over-voltage protection in a flyback power converter topology, without use of an auxiliary winding. In an example, the techniques can be implemented by circuitry configured to perform surge-aware over-voltage protection, using the switching terminal signal (sometimes referred to as a switching node signal) of the flyback power converter. The switching terminal signal may include a leakage reset portion, a leakage ringing portion, and a magnetizing ringing (or resonant) portion. To detect over-voltage conditions, the circuitry is configured to obtain, from the switching terminal signal, input and output voltages of the flyback power converter. Given these voltage values, along with the turns ratio of the flyback transformer, the circuitry is further configured to determine when an over-voltage condition is present, and to confirm that the over-voltage condition is not an input surge condition. In this manner, a fleeting surge condition is not falsely indicated as being an over-voltage condition.

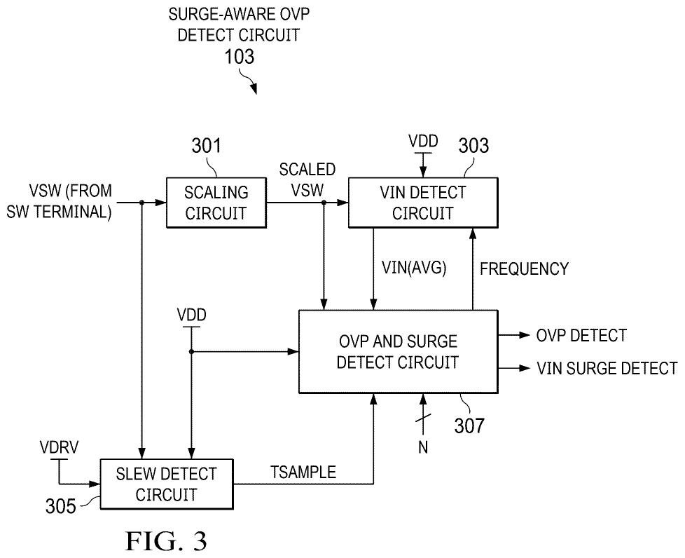

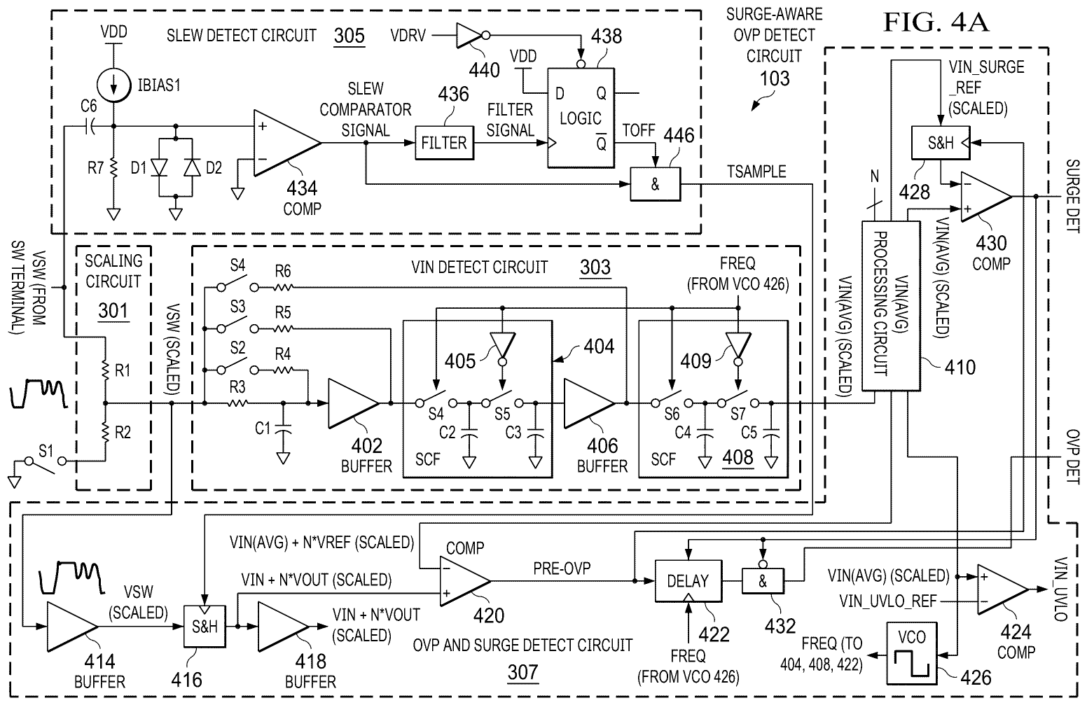

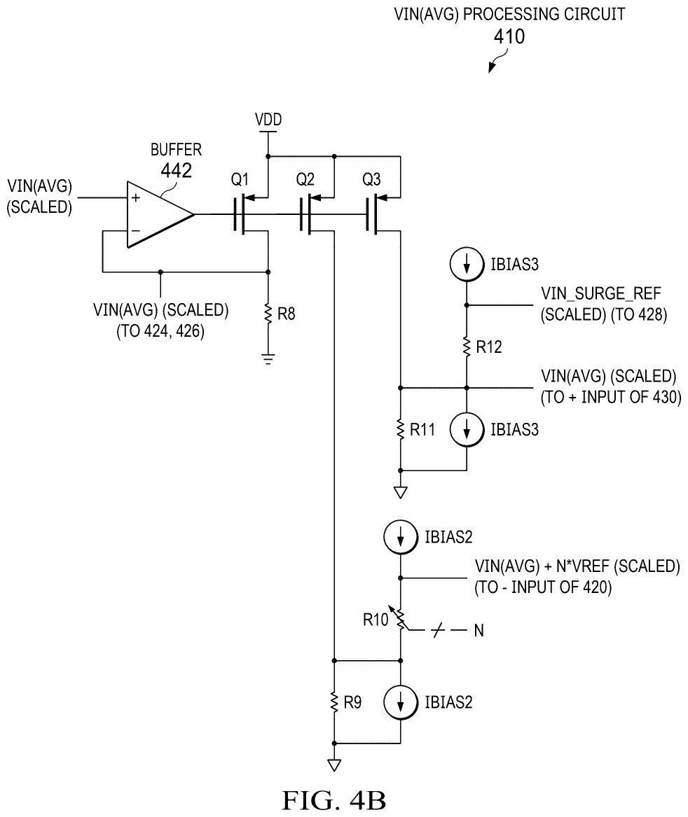

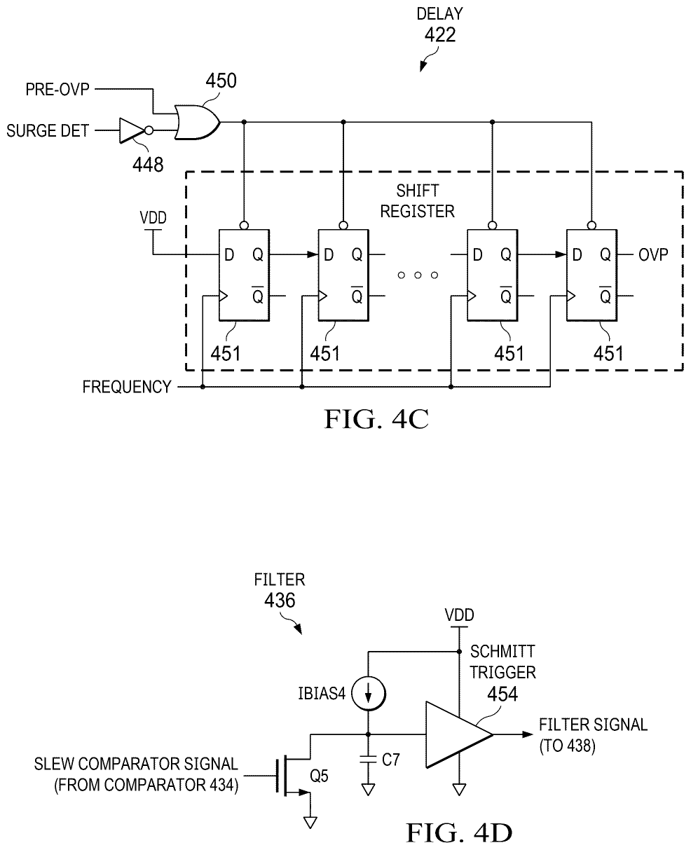

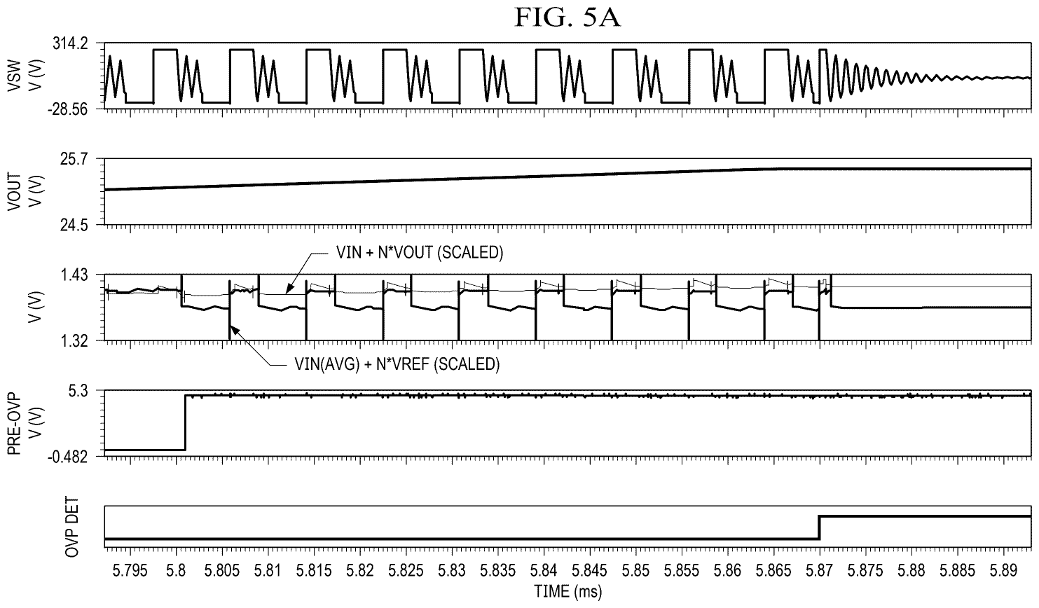

In an example, the circuitry includes first and second comparators and a logic circuit. The first comparator is configured to indicate an over-voltage protection (OVP) condition of a flyback power converter, using the switching terminal signal of the flyback power converter. The second comparator is configured to indicate an input voltage surge condition of the flyback power converter, using the switching terminal signal. The logic circuit is configured to suppress indication of an OVP condition by the first comparator, responsive to an indication of an input voltage surge condition by the second comparator. As described above, the circuitry is configured to obtain, from the switching terminal signal, input and output voltages of the flyback power converter. In an example: the first comparator is configured to compare VIN+N*VOUT to VIN(AVG)+N*VREF, and indicate an OVP condition responsive to VIN+N*VOUT being greater than VIN(AVG)+N*VREF; and the second comparator is configured to compare VIN(AVG) to a sample of the running average input voltage adjusted to provide a surge reference voltage, and indicate an input voltage surge condition responsive to VIN(AVG) being greater than the surge reference voltage. In such examples, VIN corresponds to the instantaneous input voltage of the flyback power converter, VIN(AVG) corresponds to the running average input voltage of the flyback power converter, N corresponds to the turns ratio of the flyback power converter, VOUT corresponds to the output voltage of the flyback power converter, and VREF corresponds to a voltage limit of the flyback power converter. Example circuitry for obtaining these various input and output voltage values is described herein below, with reference to FIGS. 3, 4A-D, 5A-B, and 6. In some examples, input voltage of the power converter is in the high-voltage domain (e.g., greater than 25 volts), and the circuitry includes a scaling circuit configured to scale down the switching terminal signal of the flyback power converter by a scaling factor, to obtain a scaled (low-voltage) version of switching terminal signal, and each of the values obtained for VIN(AVG), VIN+N*VOUT, and the surge reference voltage are scaled by the scaling factor.

### Circuit Architecture

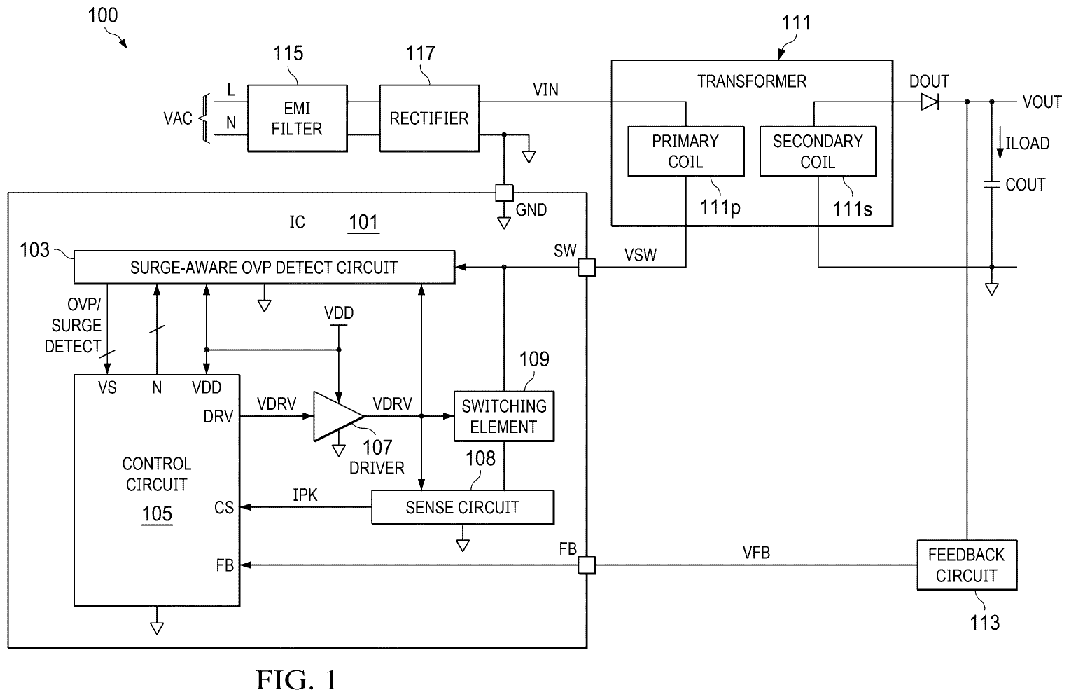

FIG. 1 illustrates a block diagram of a flyback power converter system 100 configured with an over-voltage protection (OVP) circuit, in an example. As shown, system 100 includes an integrated circuit (IC) 101, a flyback transformer 111, an output diode DOUT, an output capacitor COUT, a feedback circuit 113, an electromagnetic interference (EMI) filter 115, and a rectifier 117. In this example, flyback power converter system 100 converts an AC input voltage (VAC) to a DC input voltage (VIN) which is in turn converted by system 100 to a regulated DC output voltage (VOUT). In other examples, the DC input voltage VIN may be sourced directly, rather than derived from AC input voltage VAC.

As further shown, IC 101 includes a surge-aware OVP detect circuit 103, a control circuit 105, a driver 107, a sense circuit 108, and a switching element 109, all of which may be populated on a given substrate, such as on or otherwise part of an integrated circuit die within an integrated circuit package (e.g., ceramic flat pack with leads, dual in-line, ball grid array, pin grid array, land grid array, leaded chip carrier, quad flat no lead, to name a few examples), or on or otherwise part of a printed circuit board (e.g., single-sided, double-sided, multilayer, flex, to name a few examples), or on or otherwise part of any other suitable substrate upon which circuitry may be formed and/or populated. Each of flyback transformer 111, DOUT, COUT, feedback circuit 113, EMI filter 115, and rectifier 117 are shown to be external to IC 101 in this example, but in other examples any one or more of these components or circuits may be integrated within IC 101. An electronic system to be powered may also be coupled between the VOUT and ground terminals of system 100. The electronic system, represented here as a load current (ILOAD), may be configured to suit any number of applications (e.g., automotive systems, computing systems, communications systems, gaming systems, household appliances and consumer electronic systems, mobile electronic systems such as smartphones, or any other application that utilizes regulated power). Other examples of flyback power converter system 100 may include additional componentry not shown and/or be configured differently, and any such systems may benefit from the techniques described herein.

EMI filter 115 removes unwanted noise from the line voltage, and rectifier 117 rectifies the AC input. Any suitable EMI filter and rectifier circuitry can be used. Other examples may have VIN directly applied rather than derived from an AC source as shown. In such cases, system 100 may not include VAC, EMI filter 115, and rectifier 117. Transformer 111 allows for energy storage, energy transfer, and galvanic isolation between the input VIN and output VOUT. The turns ratio between the primary and secondary windings 111p and 111s, respectively, can be set to enable VOUT to be lower or higher than VIN. Any suitable flyback transformer may be used. In this example, flyback transformer 111 does not include any auxiliary winding used for over-voltage protection. Other examples may include one or more auxiliary windings, for instance, to provide another option for carrying out OVP, and/or for providing valley sensing and/or a bias supply.

Switching element 109 can be any suitable switching element technology, such as a gallium nitride field effect transistor (GaN FET) or other power FET, or a power bipolar junction transistor (BJT). In this example, switching element 109 is coupled between the SW and ground terminals of IC 101 via its current terminals (e.g., source/drain terminals for a FET, or emitter/collector terminals for a BJT), with sense circuit 108 coupled between switching element 109 and ground. The control terminal (e.g., gate terminal for a FET, or base terminal for a BJT) of switching element 109 is coupled to the output of driver 107. When switching element 109 is closed (on-time, or TON), primary winding 111p is connected to the input voltage VIN and the primary-side current ramps up, thus storing energy in the core of transformer 111. During this on-time, diode DOUT is reverse-biased and off, and capacitor COUT supplies the load current. When switching element 109 is open (off-time, or TOFF), energy stored in the core of transformer 111 transfers to the secondary winding 111s and current flows through diode DOUT (now forward-biased), thereby replenishing capacitor COUT and supplying the load current ILOAD. During this process, the secondary-side current ramps down as the transformer 111 core demagnetizes. The closing and opening of switching element 109, including for over-voltage protection, is controlled by IC 101, as further explained below.

Sense circuit 108 senses the primary-side peak current IPK and provides that current information (which may be a scaled version of the actual primary-side peak current IPK) to control circuit 105. The primary-side peak current IPK depends on ILOAD and the input line conditions. Any suitable current sensing circuitry that allows control circuit 105 to receive or otherwise determine the primary-side peak current IPK may be used, such as a resistor-based current sensing circuit that includes a sense FET or BJT that is a scaled down replica of switching element 109. In some examples, sense circuit 108 may also compare IPK of a given switching cycle to a reference current, and generate a current limit signal if the IPK exceeds the reference current. In such cases, the current limit signal can be provided to control circuit 105, which can in turn initiate one or more remedial actions (e.g., assert current clamping circuit, shut down converter, disconnect VIN, etc.). Feedback circuitry 113 senses the output voltage and provides a feedback voltage VFB signal to control circuit 105. The VFB signal may be, for instance, a scaled down version of VOUT. Any suitable feedback circuitry that allows control circuit 105 to receive or otherwise determine VOUT may be used, such as a resistive divider and/or an optocoupler feedback circuit as is sometimes used in flyback topologies.

As further shown, the input voltage VIN is applied to one terminal of the primary-side winding, and the other terminal of the primary-side winding is coupled to a switching node (SW) terminal of IC 101, so that IC 101 receives the switching node voltage (VSW) signal. Also, a system ground (GND) is coupled to a ground terminal of IC 101, the IPK signal generated by sense circuit 108 is coupled to a current sense (CS) terminal of IC 101, and the VFB signal generated by feedback circuit 113 is coupled to a feedback (FB) terminal of IC 101. Also, a power supply voltage VDD may be generated on IC 101, or received via another terminal of IC 101, and can be used to power circuitry therein as needed. Other examples may be configured differently and/or include other componentry, and any such configurations may benefit from the techniques described herein.

In an example operation, surge-aware OVP detect circuit 103 receives the VSW signal from the SW terminal and turns ratio (N) information from control circuit 105, and generates one or more surge-aware OVP detect signals. A given OVP signal identifies when the current value of VOUT exceeds a given OVP threshold. The OVP threshold can be fixed or variable, and depends on the given application. Control circuit 105 receives the VFB signal at its FB input terminal, the IPK signal at its CS terminal, and the one or more OVP detect signals at its voltage sense (VS) input terminal, and provides a corresponding drive voltage (VDRV) signal at its DRV output terminal. The VDRV signal, which may be, for instance, a pulse width modulated (PWM) signal, is applied to the control terminal of switching element 109 via driver 107, and may be configured by control circuit 105 to stop switching if an OVP condition is sensed, as indicated by the one or more OVP detect signals. In some examples, control circuit 105 further configures the VDRV signal for valley switching.

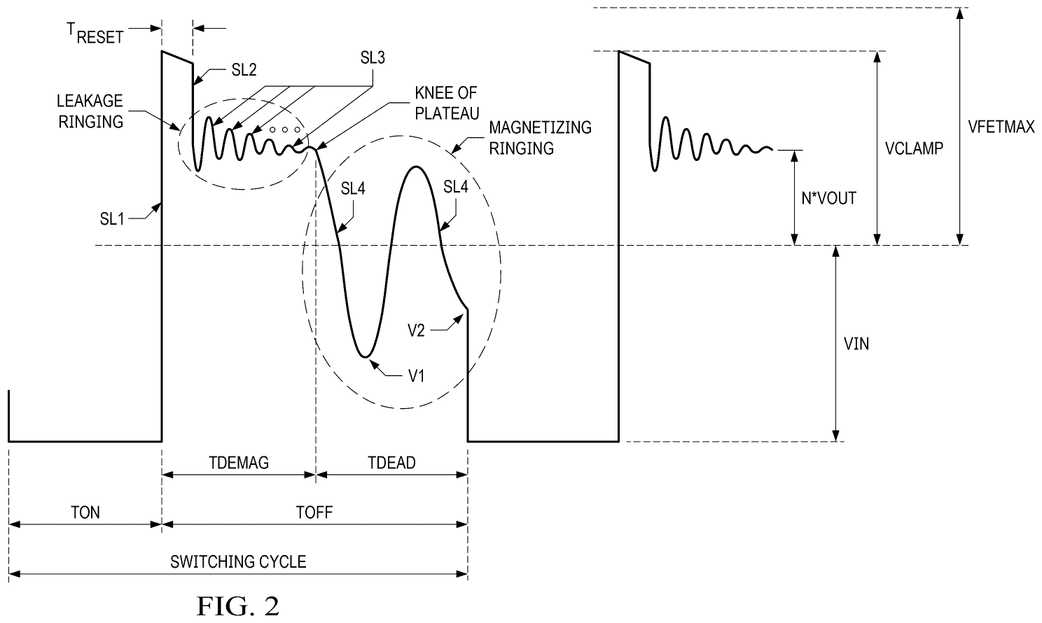

FIG. 2 illustrates an example signal of the switching terminal (or switching node, or switch node, all used interchangeably herein) of a flyback power converter. The signal may be, for instance, the VSW signal at the SW terminal of IC 101, in the example system 100 of FIG. 1. The signal is not intended to be drawn to scale, but rather is provided to show various example aspects of the signal that may manifest, and which may vary from one example to the next. As shown, a single switching cycle of the signal includes an on-time (TON) portion and an off-time (TOFF) portion. The TOFF portion includes a demagnetization (TDEMAG) portion and a resonate or deadtime (TDEAD) portion. The TDEMAG portion includes a leakage reset (TRESET) portion and a leakage ringing portion. The TDEAD portion includes a magnetizing ringing portion that includes a number of valleys (V1, V2, . . . ). In this example, switching occurred on the second valley V2, and a new switching cycle begins. Other examples may switch on the first valley V1, or a later valley (e.g., V3, V4, etc). In other examples, no valley switching scheme is used.

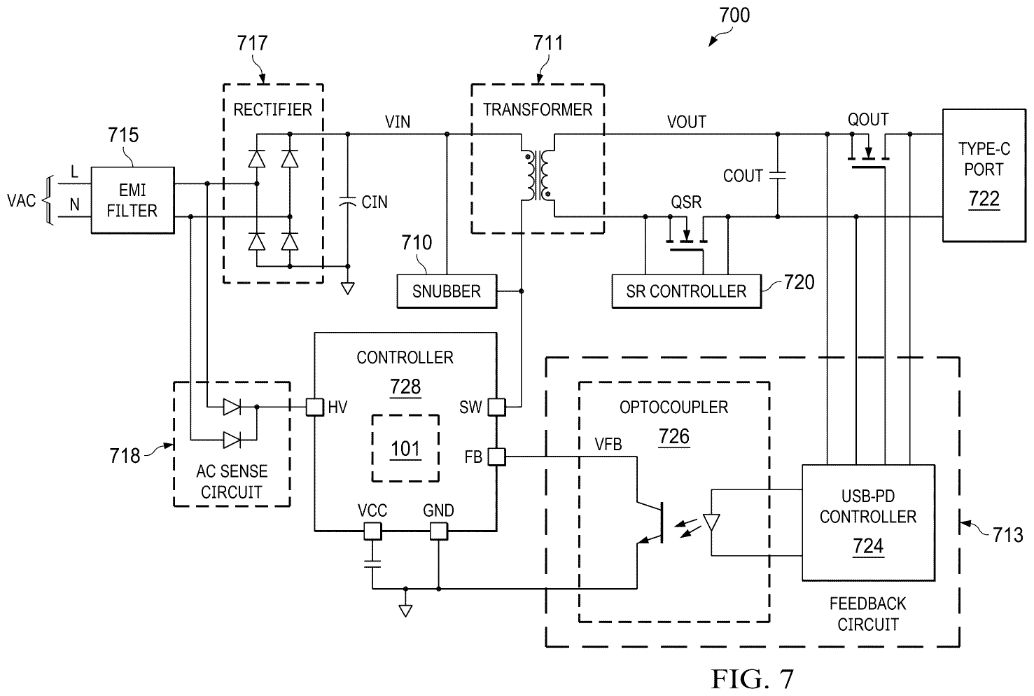

On the right side of FIG. 2, VCLAMP and VFETMAX are shown. VCLAMP is the clamp voltage (which may be provided, for example, by snubber 710 in FIG. 7). VCLAMP may be computed by:

$$VCLAMP = \% Margin * VFETMAX - VINMAX , \qquad ( Equation 1 )$$

wherein VFETMAX is the maximum voltage rating of switching element 109, the percent (%) margin provides some margin at that maximum rating, and VINMAX is the peak DC voltage based on the universal AC line range.

As further shown in FIG. 2, VIN can be determined by averaging the VSW signal. This is because no average DC voltage can exist across the inductor of the flyback transformer 111. As further shown in FIG. 2, N*VOUT+VIN corresponds to the voltage in the plateau portion of the VSW signal, and can be determined by sampling the plateau portion voltage. Thus, given that the plateau portion voltage (represented by N*VOUT+VIN in FIG. 2) can be sampled, and each of VIN and the turns ratio N are determinable or otherwise known, VOUT can also be determined:

$$VOUT = [ PV - VIN ] / N , \qquad ( Equation 2 )$$

wherein PV is the sampled plateau portion voltage. Once VOUT is known, it can be compared to a given OVP threshold voltage to determine if an OVP condition has occurred. Note that the absolute value of VOUT need not be actually computed to detect an OVP condition. For instance, the sampled value of N*VOUT+VIN can be compared to N*VREF+VIN, wherein VREF is the OVP threshold voltage, which also allows an OVP condition to be detected. Thus, in an example, system 100 is configured with circuitry configured to provide the average voltage of the VSW signal (so as to provide VIN), and circuitry configured to sample the plateau portion of the VSW signal (so as to provide N*VOUT=VIN). Examples of such circuitry are further described below, with respect to FIGS. 3-6.

As further shown in FIG. 2, there is a positive slew SL1 at the onset of the TRESET portion. The shape of the peak of the TRESET portion can vary from one configuration to the next, but in this example, slopes slightly downward from left to right. Other examples may slope upward and/or slope more severely, or be more curvilinear, or not slope or curve at all. Also, the duration of TRESET is a function of the primary-side peak current IPK. The higher the value of the primary-side peak current IPK, the longer the duration of TRESET. At the end of the TRESET window, there is a steep negative slew SL2. In an example, system 100 may be configured with, or used in conjunction with, a circuit configured to detect and blank out the TRESET portion, so as to suppress or otherwise avoid sampling of the TRESET portion, for purposes of assessing OVP and surge conditions. The blanking period may be fixed, or variable, such as the example case where the blanking period varies based on IPK, and may be set to be slightly longer than TRESET for a given configuration.

As further shown in FIG. 2, the leakage ringing portion includes multiple occurrences of negative slew SL3, and the magnetizing ringing portion includes multiple occurrences of negative slew SL4. The ringing of the leakage ringing portion is due to switch node parasitics such as parasitic capacitance of switching element and transformer, and has a relatively higher frequency than the ringing of the magnetizing ringing portion. The ringing of the magnetizing ringing portion occurs when the secondary winding energy declines toward (or to) zero. For a given application, the slowest leakage ringing may be, for instance, 2× or more higher than the fastest magnetizing ringing. This means that any given slew SL3 will end more quickly than the slew SL4 of the first valley V1. Thus, in an example, slew detect circuitry works in conjunction with logic and a leakage ringing filter having a period that is longer than any signal period of the leakage ringing, but shorter than the time it takes for the slew SL4 of the first valley to end, to generate a sampling control signal that remains active during the plateau portion of the VSW signal and turns off responsive to expiration of the leakage ringing filter. In this manner, gated and accurate sampling of the plateau portion voltage is enabled.

### Surge-Aware OVP Circuitry

FIG. 3 illustrates a block diagram of surge-aware OVP detect circuit 103 of the system 100 of FIG. 1, in an example. As shown, circuit 103 includes a scaling circuit 301, a VIN detect circuit 303, a slew detect circuit 305, and an OVP and surge detect circuit 307. Other examples may be configured differently, and with different levels of integration, but still operate to provide similar functionality. For instance, in another example, each of scaling circuit 301, VIN detect circuit 303, and slew detect circuit 305 may be integrated into and OVP and surge detect circuit 307. In an example operation, circuit 103 receives the switching terminal signal VSW at its input, and is configured to generate an OVP signal at its output, in response to an over-voltage condition (based on a given OVP threshold voltage appropriate for the given application). As further shown in this example, circuit 103 may also generate a VIN surge detect signal at its output, in response to a VIN surge condition. A surge can occur on the AC line voltage, which may occur for a number of factors external to the power converter, and which in turn causes VIN to rapidly rise (e.g., 150V/50 us). An over-voltage condition occurs when VOUT of system 100 exceeds the given OVP threshold, which causes OVP and surge detect circuit 307 to generate an OVP detect signal, which in turn shuts down power converter switching to prevent damage to the connected devices (load) from excessive voltage. Circuit 103 can distinguish between these OVP and surge conditions, and suppress indication of a detected OVP condition, when a VIN surge condition is also present. Advantageously, no auxiliary winding is needed in generating the OVP and surge detect signals.

As described above, the VSW signal includes a leakage reset portion, a leakage ringing portion, and a magnetizing ringing portion, and can be used to detect VIN and VOUT, which in turn can be used for purposes of assessing OVP and surge conditions. Scaling circuit 301 includes an input that receives the switching terminal signal VSW (from the SW terminal of system 100), and is configured to scale the VSW signal by a scaling factor, so as to generate a scaled version of the VSW signal. The scaling can be accomplished passively or actively. For example, scaling circuit 301 may be a resistive voltage divider configured to passively scale the VSW signal from a high-voltage domain (e.g., >25 volts, such as 300 volts or 700 volts) to a low-voltage domain (e.g., 5 volts or less). In another example, scaling circuit 301 may be an amplifier configured with a gain of less than 1, so as to actively attenuate (scale) the VSW signal to a target level. More generally, any type of level shifting circuitry may be used. The scaling factor provided by scaling circuit 301 can be set for the particulars of a given application. Other examples may not include scaling circuit 301, such as an example where the input voltage is relatively low (e.g., 10 volts or less) or otherwise on par with other voltages of circuit 103 and/or circuit 103 is configured to handle the unscaled VSW signal.

VIN detect circuit 303 includes an input to receive the scaled VSW signal, a power supply (VDD) input, a frequency signal (FREQ) input, and a VIN(AVG) output. VIN detect circuit 303 is configured to determine a running average input voltage VIN(AVG) of the flyback power converter based on the scaled VSW signal. In more detail, recall from the above description of FIG. 2 that the average of the VSW signal is VIN (accounting for the scaling factor, if applicable), as no average DC voltage can exist across the flyback transformer inductor. Thus, in an example, VIN detect circuit 303 is configured to determine VIN(AVG) by filtering the scaled VSW signal through a low-pass filter. In one such example, the low-pass filter is a third-order filter that includes a first order resistor-capacitor (RC) filter followed by two switched capacitor filters. The cut-off frequency of the switched capacitor filters may be proportional to, or otherwise dependent on, VIN, by virtue of the FREQ input which is generated by OVP and surge detect circuit 307 as further described below. This allows the low-pass filter response to be faster at higher VIN values and slower at lower VIN values, which in turns allows surge to be detected faster at higher VIN values compared to lower VIN values.

Slew detect circuit 305 includes a VSW signal input, a VDD input, a VDRV input, and an output that provides a sampling control (TSAMPLE) control signal. Slew detect circuit 305 is configured to detect negative slews SL3 and SL4, and to generate the TSAMPLE control signal. The TSAMPLE control signal is used to gate sampling of the plateau portion voltage of the VSW signal, which in some examples may be done by OVP and surge detect circuit 307, although it may be done elsewhere in other examples. In some examples, slew detect circuit 305 includes a negative slew detector that works in conjunction with a leakage ringing filter and logic that allows the TSAMPLE control signal to be otherwise toggle high during the plateau portion so as to allow for sampling, and holds the TSAMPLE control signal low after the leakage ringing filter expires so as to stop sampling. The VDRV signal received at the VDRV input can be used to set the logic for operation during the TOFF portion of the switching cycle (where plateau sampling occurs), and to reset the logic during the TON portion. A sample and hold circuit enabled by the TSAMPLE control signal can be used to responsively sample the plateau portion voltage. Thus, accurate gated sampling of the plateau portion (which corresponds to the voltage: N*VOUT+VIN) is achieved.

As described above, sampling of the TRESET portion of the VSW signal may be avoided by circuitry configured to detect and blank out the TRESET portion. Such circuitry may be included, for instance, in slew detect circuit 305, although it may be elsewhere in other examples. In any case, the blanking period may be fixed in some examples, while in other examples is variable, such as the example case where the blanking period is based on IPK and set to slightly longer than TRESET for a given configuration. An example IPK-aware blanking scheme for bypassing the TRESET portion of the VSW signal is described in U.S. patent application Ser. No. 19/016,101 filed Jan. 10, 2025, which is herein incorporated by reference in its entirety. One such example includes a slew detector configured to detect positive slew SL1 and that works in conjunction with a blanking circuit and logic configured to suppress slew reporting (e.g., SL2) until the given delay period expires. Sampling of the plateau portion of the VSW signal may then commence.

OVP and surge detect circuit 307 includes an input to receive VDD, an input to receive the scaled VSW signal, an input to receive VIN(AVG), an input to receive the turns ratio (N), an input to receive the TSAMPLE control signal, an output to provide the frequency signal (FREQ), an output to provide the OVP detect signal, and an output to provide the VIN surge detect signal. OVP and surge detect circuit 307 is configured to use the scaled versions (if applicable, and otherwise may use non-scaled versions) of the VSW signal and the VIN(AVG) to detect if an OVP condition is present, and if so, to suppress indication of the OVP condition responsive to an input voltage surge condition being present. In this manner, OVP and surge detect circuit 307 is configured to discern the difference between a true OVP condition and a false OVP condition that is actually an input voltage surge condition.

In one such example, OVP and surge detect circuit 307 is configured to sample voltage of the plateau portion of the VSW signal, responsive to the TSAMPLE control signal, which provides the voltage value of VIN+N*VOUT (as described with reference to FIG. 2). OVP and surge detect circuit 307 is further configured to compare VIN+N*VOUT to VIN(AVG)+N*VREF, and indicate an OVP condition responsive to VIN+N*VOUT being greater than VIN(AVG)+N*VREF. In this example case, VIN corresponds to the instantaneous input voltage of the flyback power converter, VIN(AVG) corresponds to a running average input voltage of the flyback power converter provided by VIN detect circuit 303, N corresponds to a turns ratio of the flyback transformer (e.g., provided by control circuit 105), VOUT corresponds to an output voltage of the flyback power converter, and VREF corresponds to a voltage limit of the flyback power converter (which may also be referred to as the OVP threshold). OVP and surge detect circuit 307 is further configured to compare VIN(AVG) to a sample of the running average input voltage adjusted by a voltage to simulate or otherwise reflect an input surge condition, and indicate an input voltage surge condition responsive to VIN(AVG) being greater than the sample of the surge-adjusted running average input voltage. OVP and surge detect circuit 307 is further configured to suppress an indication of an OVP condition, responsive to an input surge condition also being indicated at that time.

FIG. 4A illustrates a schematic diagram of surge-aware OVP detect circuit 103 of FIG. 3, in an example. The above relevant description with respect to circuit 103 is equally applicable here, and is further expanded on with example arrangements of circuitry to implement the functionality described herein. Other examples may be configured differently, but still achieve similar functionality.

In this example, scaling circuit 301 includes a resistor divider that includes resistors R1 and R2, along with a switch S1. The divider ratio can vary from one example to the next, but in one example case is 1:201, wherein R1=200 KΩ and R2=1 KΩ. In one such example case, a maximum voltage of about 600 volts on the VSW signal would be scaled down to about 3 volts. Switch S1 may be used, for example, to enable/disable scaling circuit 301 (and surge-aware OVP detect circuit 103) responsive to a control signal from control circuit 105. Other examples may not include switch S1, or may provide such a switch elsewhere in the circuit (e.g., between SW terminal and resistor R1). In some examples, switch S1 may be open during start-up and low power mode, and closed during normal operation mode. Still other examples may include an active attenuator circuit.

With further reference to FIG. 4A, VIN detect circuit 303 is configured with a third-order low-pass filter which includes a first order RC filter (resistor R3 and capacitor C1) followed by two switched capacitor filters (SCF 404 and SCF 408). SCF 404 includes switches S4 and S5, along with capacitors C2 and C3 and inverter 405, and SCF 408 includes switches S6 and S7, along with capacitors C4 and C5 and inverter 409. As further shown in the example of FIG. 4A, the switching of switches S4 through S7 is controlled by the FREQ signal from OVP and surge detect circuit 307, thus allowing the cut-off frequency of the switched capacitor filters 404 and 408 to be proportional to, or otherwise dependent on VIN. A unity gain buffer 402 is provided between the RC filter stage and SCF 404, and unity gain buffer 406 is provided between SCF 404 and SCF 408. Switches S2, S3, and S4, along with resistors R4, R5, and R6, may be used to pre-charge capacitors C1 through C5 before start-up and in low power mode. Similar to switch S1, switches S2, S3, and S4 may be, for example, responsive to one or more control signals from control circuit 105, and may be engaged during start-up and low-power modes.

In an example operation, VIN detect circuit 303 is configured to low-pass filter the VSW signal, to obtain a running average input voltage VIN(AVG) of the flyback power converter. Both the VSW signal and the VIN(AVG) may be scaled in accordance with the scaling factor of scaling circuit 103, if applicable. As described above, VIN(AVG) can be determined by averaging the VSW signal, because no average DC voltage can exist across the inductor of the flyback transformer 111. As further shown in the example of FIG. 4A, VIN(AVG) is used by OVP and surge detect circuit 307 to determine if an OVP and input voltage surge conditions are present. In some such examples, VIN(AVG) may also be used for other functions, such as brown-out detection. Although the various component values can vary from one example to the next, one such example has the following: R3=8 MΩ; R4=50 KΩ; R5=50 KΩ; R6=50 KΩ; C1=5 pF; C2=500 fF; C3=5 pF; C4=500 fF; and C5=5 pF, and the cut-off frequency of SCF 404 and SCF 408 can vary from 5 KHz (which corresponds to VIN(AVG) of about 60 volts and a FREQ signal of about 333 KHz) to 15 KHz (which corresponds to VIN(AVG) of about 400 volts and a FREQ signal of about 1 MHz).

With further reference to FIG. 4A, slew detect circuit 305 is configured to detect negative slews of the VSW signal using capacitive slew detection, and to generate the TSAMPLE control signal. The sensing portion of slew detect circuit 305 includes current source IBIAS1, capacitor C6, resistor R7, and a clamp that includes diodes D1 and D2. Each of these components can be rated to meet the specifications of the given application (e.g., high-voltage automotive applications where VSW can vary over a wide range, such as from −2 volts to 1000 volts). Also, some or all of the sensing circuitry may be integrated with other componentry. For instance, in some examples, capacitor C6 is a high-voltage metal-insulator-metal (MIM) capacitor that is integrated with a semiconductor die that also includes switching element 109 (e.g., GaN power FET). Resistor R7 and current source IBIAS1 can be set to provide a bias voltage level at the non-inverting input of comparator 434 (e.g., just above ground potential, such as in the range of 50 millivolts to 100 millivolts). For instance, in one example, capacitor C6=150 femtofarads (e.g., 700 volt rating), resistor R7=50 KΩ, and current source IBIAS1 is set to about 1.0 to 1.25 microamps, so as to bias the non-inverting input of comparator 434 to about 50 millivolts to 62.5 millivolts. In an example operation, IBIAS1, C1, and R1 effectively convert the SW node slew to current, and the D1-D2 clamp is used to restrict voltage swing (e.g., limit to about 0.6 volts or 0.7 volts, for silicon diodes). Other suitable slew detector configurations may be used.

As further shown, comparator 434 receives the output of the sensing portion of slew detect circuit 305 and generates a slew comparator signal at its output. In this example, the threshold voltage at the inverting input of comparator 434 is fixed (ground potential); however, in other examples, the threshold voltage may be variable, so as to allow the slew detect circuit 305 to detect both positive slew and negative slew, wherein positive slew detection mode can be used to detect SL1 of the VSW signal for purposes of blanking out the TRESET portion of the VSW signal. An example of circuitry for providing such a variable threshold voltage is described in the previously incorporated U.S. patent application Ser. No. 19/016,101. In other examples, a dedicated circuit can be used to blank out the TRESET portion. In one such example, a positive slew detector may be configured to also receive the output of the sensing portion of slew detect circuit 305 and provide a low output until the positive slew of SL1 of a given switching cycle is detected and a delay period (fixed or variable) that runs from the detection to SL1 to just past SL2 has expired, at which point the dedicated circuit provides a high output, which may in turn be received by, for example, a third input of AND-gate 446, so as to further inform the TSAMPLE control signal when the TRESET portion has passed. More generally, any circuitry can be used to detect passing of, or otherwise ignore, the TRESET portion so as to allow sampling of the plateau portion only. In any such cases, sampling of the plateau portion of the VSW signal may commence after the TRESET portion has passed, and continue until the first occurrence of SL4 during the given switching cycle.

As further shown in the example of FIG. 4A, slew detect circuit 305 further includes logic 438, an inverter 440, a leakage ringing filter 436, and an AND-gate 446 (indicated with the & symbol). In this example, logic 438 is implemented with a D-type synchronous, active low reset, positive edge triggered flip-flop, wherein drive signal VDRV is applied to the reset input of logic 438 via inverter 440, the data (D) input of logic 438 is tied high via power supply VDD, and the clock input of logic 438 receives the slew comparator signal from comparator 434. The TOFF control signal at the Q-bar output of logic 438, in conjunction with AND-gate 446, controls sampling carried out by sample and hold (S&H) circuit 416, which is part of OVP and surge detect circuit 307 in this example. Other configurations that achieve similar functionality may be used. For instance, in another example, logic 438 is implemented with a D-type synchronous, active high reset, positive edge triggered flip-flop, wherein drive signal VDRV is applied directly to the reset input of logic 438 (no inverter 440).

In an example operation, when the VDRV signal is high (during the TON portion of the VSW signal, for a current switching cycle), logic 438 is reset and the TOFF control signal at the Q-bar output of logic 438 is high, which allows the TSAMPLE control signal at the output of AND-gate 446 to be high when the slew comparator signal is also high, which effectively turns on or otherwise enables sampling by S&H 416. When the VDRV signal goes low (which initiates the TOFF portion of the VSW signal, for the current switching cycle), logic 438 becomes set or otherwise ready to be triggered by the next positive going (rising) edge received from filter 436 at the clock input of logic 438. The first positive going edge from filter 436 occurs one delay period (e.g., 280 nanoseconds) after the first negative slew SL4 (FIG. 2) of the VSW signal is detected. In more detail, when the first negative slew SL4 commences, the slew comparator signal at the output of comparator 434 transitions from high to low. This low slew comparator signal is received by filter 436, which in turn causes the filter signal at the output of filter 436 to transition from low to high, after expiry of the delay period configured into filter 436, as further described below with reference to the example of FIG. 4D. This positive going edge of the filter signal is received at the clock input of logic 438, which in turn triggers a change in state of the TOFF control signal at the Q-bar output of logic 438 from high to low, which in turn causes the TSAMPLE control signal at the output of AND-gate 446 to go low, thereby disabling further sampling by S&H 416. This low state of the TSAMPLE control signal at the Q-bar output of logic 438 is held until VDRV goes high again (which initiates the TON portion of the next switching cycle), which resets logic 438 and thus causes the TOFF control signal at the Q-bar output of logic 438 to go high. The process repeats for that switching cycle, and so on. Also, recall from above that the TSAMPLE control signal may also be informed as to when the TRESET portion of the VSW signal has passed for a given switching cycle.

As further shown in FIG. 4A, OVP and surge detect circuit 307 includes VIN(AVG) processing circuit 410, unity gain buffer 414, sample and hold circuit 416, unity gain buffer 418, comparator 420, delay 422, comparator 424, voltage controlled oscillator (VCO) 426, sample and hold circuit 428, comparator 430, and AND-gate 432. In operation, OVP and surge detect circuit 307 is configured to receive the VSW signal as well as VIN(AVG) and turns ratio N, and generate a number of voltage values that are used to determine if OVP condition is present, and if so, to suppress indication of the OVP condition if an input voltage surge condition is present, thereby allowing for surge-aware over-voltage protection. The generated voltage values in one example are listed in Table 1. As further shown in FIG. 4A, each of VSW signal, VIN(AVG), and the generated voltage values may be scaled by the scaling factor attributable to scaling circuit 301, if applicable.

TABLE 1
Voltages generated by OVP and surge detect circuit 307

| | |
|---|---|
| VIN(AVG) | Buffered version of VIN(AVG) provided by |
| | VIN detect circuit 303. |
| VIN_SURGE_REF | Buffered version of VIN(AVG) adjusted to |
| | reflect a surge condition. |
| VIN(AVG) + N*VREF | Buffered version of VIN(AVG) adjusted to |
| | reflect an OVP condition. |
| VIN + N*VOUT | Sampled voltage of plateau portion of the |
| | VSW signal. |

VIN(AVG) processing circuit 410 receives VIN(AVG) (scaled) from VIN detect circuit 303 and turns ratio N from control circuit 105, and provides a number of buffered outputs which are listed in Table 1 above. In this particular example, a first VIN(AVG) (scaled) output is provided to the non-inverting input of comparator 430, a second VIN(AVG) (scaled) output is provided to the non-inverting input of comparator 424 and to the input of VCO 426, a VIN(AVG)+N*VREF (scaled) output is provided to the inverting input of comparator 420, and a VIN_SURGE_REF (scaled) output is provided to the input of sample and hold 428. In this example, the VIN(AVG)+N*VREF (scaled) output provides a first threshold voltage that is used by comparator 420 to determine if an OVP condition exists, and the VIN_SURGE_REF (scaled) output provides a second threshold voltage that is used by comparator 430 to determine if an input voltage surge condition exists. FIG. 4B shows an example of VIN(AVG) processing circuit 410, and is further described below.

Buffer 414 provides the scaled VSW signal from scaling circuit 301 to the input of sample and hold circuit 416, which is gated by the TSAMPLE control signal, so as to allow for sampling of the plateau portion of the VSW signal. As described above, the voltage of the plateau portion corresponds to the voltage value of VIN+N*VOUT (scaled), which is provided at the output of sample and hold circuit 416. Buffer 418 may be used to provide the VIN+N*VOUT (scaled) value to an output terminal of circuit 307, if so desired (e.g., for monitoring and/or use in other functions).

The VIN+N*VOUT (scaled) value from sample and hold circuit 416 is also provided to the non-inverting input of comparator 420, which also receives VIN(AVG)+N*VREF (scaled) from circuit 410 at its inverting input, and provides the pre-OVP signal at its output. In this manner, comparator 420 is configured to compare VIN+N*VOUT (scaled) with VIN(AVG)+N*VREF (scaled), to determine if an OVP condition may exist. In particular, if VIN+N*VOUT (scaled) is greater than VIN(AVG)+N*VREF (scaled), then the pre-OVP signal at the output of comparator 420 goes high thereby signaling a possible OVP condition; otherwise the pre-OVP signal is low thereby indicating no OVP condition exists. The reason the OVP condition at this point is referred to as a possible OVP condition is that it may be a false positive, caused by an input surge condition.

To this end, and as further shown in FIG. 4A, the pre-OVP signal is also used to gate contemporaneous sampling by sample and hold circuit 428 of a surge-adjusted version of the VIN(AVG) (scaled) voltage provided by circuit 303. This surge-adjusted version of the VIN(AVG) (scaled) is referred to herein as VIN_SURGE_REF (scaled), and is used as a surge reference voltage for purposes of determining the presence of an input voltage surge condition contemporaneously with the pre-OVP condition. In more detail, sample and hold circuit 428 samples the VIN_SURGE_REF (scaled) voltage provided by circuit 410 responsive to the pre-OVP signal going high, and comparator 430 receives the sampled VIN_SURGE_REF (scaled) at its inverting input and the running VIN(AVG) (scaled) voltage at its non-inverting input, thus allowing comparator 430 to determine if VIN(AVG) (scaled) is greater than VIN_SURGE_REF (scaled). If so, the surge detect signal at the output of comparator 430 goes high thereby signaling the presence of an input surge condition; otherwise the surge detect signal at the output of comparator 430 is low thereby indicating no input surge condition exists. As described above, detection of a surge condition can be used to suppress reporting of a contemporaneously reported OVP condition.

In more detail, and with reference to FIG. 4A, AND-gate 432 receives the surge detect signal from comparator 430 at one of its inputs via an inverter, and the pre-OVP signal from comparator 420 at the other of its inputs via delay 422. Delay 422 is used to delay reporting of the pre-OVP signal so as to allow a potential surge condition to be assessed by comparator 430. The delay provided by delay 422 is a function of the FREQ signal, which is proportional to VIN(AVG), which recognizes that surge can be detected faster at higher VIN(AVG) values compared to low VIN(AVG) values. Delay 422 is further described below with reference to FIG. 4C. In an example operation, the output of AND-gate 432 provides the OVP detect signal, which is high only when the pre-OVP signal is high and the surge detect signal is low. If the surge detect signal is high, then the OVP condition is deemed false and therefore suppressed or otherwise not declared by AND-gate 432; likewise, if the pre-OVP signal is low, then no OVP condition is declared by AND-gate 432.

As further shown in FIG. 4A, comparator 424 receives VIN(AVG) at its non-inverting input from circuit 410, and has its inverting input set to an undervoltage lockout threshold (VIN_UVLO_REF), so that comparator 424 can report brownout conditions and initiate remedial action (e.g., disable system 100 when VIN(AVG) is too low for correct operation). Note the inputs of comparator 424 may be reversed and similar functionality will still be provided (active high output instead of active low output). VCO 426 also receives VIN(AVG) at its input from circuit 410, and generates the FREQ signal at its output. In this manner, the FREQ signal is proportional to VIN(AVG), thereby allowing the cut-off frequency for each of SCF 404 and SCF 408 to be proportional to VIN(AVG), and the delay period provided by delay 422 to be inversely proportional to VIN(AVG). In some such examples, for instance, the FREQ signal provided by VCO 426 is 333 KHz with a VIN(AVG) input of 60 volts, and 1 MHz with a VIN(AVG) input of 420 volts. Other examples may be configured differently.

FIG. 4B shows an example of VIN(AVG) processing circuit 410. As shown in this example, VIN(AVG) processing circuit 410 receives VIN(AVG) (scaled) and turns ratio N as inputs, and provides a number of outputs including VIN(AVG)+N*VREF (scaled), VIN_SURGE_REF (scaled), and first and second instances of VIN(AVG) (scaled). VIN(AVG) processing circuit 410 includes a buffer 442 that receives VIN(AVG) (scaled) at its non-inverting input and has its output coupled to the control terminals (e.g., gates) of transistors Q1 through Q3, which are arranged in a current mirror configuration to create multiple copies of VIN(AVG) (scaled). The transistors in this example are p-channel field effect transistors (PFETs), although other transistor technology and suitable mirror circuitry may be used (e.g., bipolar junction transistors). Resistors R8 through R12 and current sources IBIAS2 and IBIAS3 provide biasing. The source terminals of transistors Q1 through Q3 are coupled to VDD (e.g., 5 volts). The drain of transistor Q1 is coupled to ground (e.g., 0 volts) via resistor R8. The drain of transistor Q2 is coupled to ground via resistor R9. The drain of transistor Q3 is coupled to ground via resistor R11.

In operation, buffer 442 has its output coupled to the gates of transistors Q1 through Q3 and its inverting input coupled to the drain of Q1, which provides VIN(AVG) (scaled), thereby setting the current in transistor Q1 as VIN(AVG)/R8 (scaled), and each of transistors Q2 and Q3 copies that current and provides VIN(AVG) (scaled) at its drain as well. The drain of transistor Q1 is further coupled to the non-inverting input of comparator 424 and the input of VCO 426, allowing both to receive VIN(AVG) (scaled) as input. Also, IBIAS2 and resistor R10 operate to adjust VIN(AVG) (scaled) at the drain of transistor Q2 by N*VREF (scaled) so as to provide VIN(AVG)+N*VREF (scaled), wherein VREF represents the scaled OVP threshold and N is the turns ratio. The resulting VIN(AVG)+N*VREF (scaled) is provided to the inverting input of comparator 420. Also, IBIAS3 and resistor R12 operate to adjust VIN(AVG) (scaled) at the drain of transistor Q3 by a scaled voltage to provide a scaled input surge voltage threshold referred to as VIN_SURGE_REF (scaled). VIN_SURGE_REF (scaled) is provided to the input of sample and hold circuit 428, and VIN(AVG) (scaled) at the drain of Q3 is provided to the non-inverting input of comparator 430.

In an example, R8=800 KΩ, or other suitably high impedance to maintain relatively low power dissipation. Resistor R10 may be variable as shown in this example, to allow for a range of turns ratios and/or OVP thresholds. In one such example, for instance, resistor R9=800 KΩ, IBIAS2=1 microamp (μA), VREF=25 volts, N ranges from a minimum turns ratio of 6 and to a maximum turns ratio of 7.875, and resistor R10 can be varied from 750 KΩ to 980 KΩ with a total of 16 steps (4 bit resolution). Table 2 further illustrates one such example. The N*VREF (scaled) value corresponds to the voltage drop across resistor R10, which is added to VIN(AVG) (scaled) value which corresponds to the voltage drop across resistor R9.

TABLE 2
Example with variable turns ratio (N)

| | N*VREF | | N*VREF | | R10 |
|---|---|---|---|---|---|
| N | (VREF = 25 volts) | | (scaled, 1:201) | | (IBIAS2 = 1 μA) |
| 6 | 150 | volts | .75 | volts | 750 KΩ |
| 6.125 | 153.125 | volts | .765 | volts | 765 KΩ |
| . . . | . . . | | . . . | | . . . |
| 7.75 | 193.75 | volts | .965 | volts | 965 KΩ |
| 7.875 | 196.875 | volts | .98 | volts | 980 KΩ |

Resistor R12 is fixed in this example, but may be variable in other examples (in a fashion similar to R10 as described above) to allow for a range of input surge. In one example, resistor R11=800 KΩ, IBIAS3 is 1 microamp (μA), and resistor R12=40 KΩ. The VIN(AVG) (scaled) value corresponds to the voltage drop across resistor R11, and the voltage drop across resistor R12 (which in this example is about 40 millivolts) corresponds to the scaled voltage added to VIN(AVG) (scaled) to provide VIN_SURGE_REF (scaled). Accounting for the example 1:201 scaling factor, the 40 millivolts drop across resistor R11 translates to 8 volts unscaled. In such an example, an 8 volt or more increase on an expected VIN(AVG) in the range of 300 volts to 600 volts would be indicative of an input voltage surge condition. In other examples, the VIN_SURGE_REF value can be set on a percentage basis, such as 101% to 110% of the expected VIN(AVG). In still other examples, the VIN_SURGE_REF value can be set empirically based on historical data of a given system, or theoretical data of a given system. Other examples may have a different input voltage surge reference level. More generally, the voltage added to VIN(AVG) can be set a level so as to provide a VIN_SURGE_REF value that would likely only be exceeded during an input voltage surge condition for a given application.

FIG. 4C shows an example of delay 422. As described above, delay 422 allows surge to be detected faster at higher VIN(AVG) values compared to low VIN(AVG) values. In this manner, the surge delay provided by delay 422 is inversely proportional to input voltage. In more detail, the window of available delay that can be provided by delay 422 is dependent on the quasi-resonant (QR) power (P) capability of system 100, which is a function of VIN(AVG), primary-side peak current (IPK), and N*VOUT (first valley QR power), as shown in Equation 3:

$$P = 0 \text{.5} * IPK * VIN ( AVG ) * N * VOUT / ( VIN ( AVG ) + N * VOUT ) . \qquad ( Equation 3 )$$

The frequency of operation during QR operation is also a function of VIN, IPK, and N*VOUT, as well as primary-side inductor L (inductance of primary coil 111p). The window of available delay provided by delay 422 is made with the VIN dependent clock (FREQ, generated by VCO 426), and as previously described above the VIN detect circuit 303 is modulated with the VIN dependent clock FREQ through SCF 404 and 408. The end result is filter response is faster at high VIN and slower at low VIN, which in turn means that surge can be detected faster at higher VIN compared to low VIN.

As shown in the example of FIG. 4C, delay 422 includes an inverter 448, an OR-gate 450, and a shift register including N flip-flops 451. In one example, the shift register includes forty flip-flops (e.g., N=40), so as to provide a delay of 40 cycles of a VIN(AVG) proportional clock (which is the FREQ signal in this example). In operation, delay 422 is enabled by the pre-OVP signal going high and will set the OVP signal at its output high N cycles later. This is only prevented by surge detect signal going high or the pre-OVP signal going low. Continuing with the above examples, the delay provided by delay 422 may be, for instance, 40 μs for when VIN(AVG) is equal to 400 volts, and 120 μs when VIN(AVG) is equal to 60 volts. Other examples may be configured differently. More generally, delay 422 may be configured to provide shorter delay(s) at relatively higher VIN(AVG) values and longer delay(s) at relatively lower VIN(AVG) values. Still other examples may not include delay 422.

FIG. 4D shows an example of leakage ringing filter 436. As shown, leakage filter 436 includes capacitor C7, a current source IBIAS4, a Schmitt trigger 454, and transistor (switch) Q5. Capacitor C7 is coupled between the input of Schmitt trigger 454 and ground, and is switchable via transistor Q5 based on the slew comparator signal from comparator 434. In this example, transistor Q5 is implemented with an n-channel field effect transistor (NFET), but any suitable switching technology can be used. In an example operation, when the slew comparator signal from comparator 434 goes low (thereby indicating the beginning of a negative slew), transistor Q5 turns off (opens), thereby releasing the pull-down on the input node of Schmitt trigger 454 and allowing capacitor C7 to be charged with constant current source IBIAS4. When the voltage on the input node of Schmitt trigger 454 (and across capacitor C7) reaches the high threshold of Schmitt trigger 454 (VTH_SCHMITT_454), the filter signal at the output of Schmitt trigger 454 goes high and is provided to the clock input of logic 438. Subsequently, when the slew comparator signal from comparator 434 goes high (thereby indicating the beginning of a positive slew), transistor Q5 turns on (closes) thereby pulling the input node of Schmitt trigger 454 to a low state, which in turn causes the filter signal output of Schmitt trigger 454 to be low. The time from when the slew comparator signal from comparator 434 goes low to when the output of Schmitt trigger 454 goes high corresponds to the leakage filter time. In this manner, the filter signal is a blanking signal that effectively suppresses negative slew that run for less than the leakage filter time, such as the negative slews of the leakage ringing portion of the VSW signal. The value of the leakage filter time can be determined as: LEAKAGE FILTER TIME=C7_CAPACITANCE*VTH_SCHMITT_454/IBIAS4.

In one example case, the following values are used: C7 is 448 femtofarads, IBIAS4 is about 2 microamps, and the high threshold of Schmitt trigger 454 (VTH_SCHMITT_454) is 1.25 volts, which causes the filter signal to transition to its high state about 280 ns after the slew comparator signal from comparator 434 goes low. More generally, the leakage filter time can be set to somewhere between the signal period of the leakage ringing portion and the signal period of the magnetization ringing portion. In more detail, an in accordance with some examples, the slowest frequency of the leakage ringing portion is about two times or more faster than the fastest frequency of the magnetization ringing portion, such that the shortest signal period of the magnetization ringing portion is about two times or more longer than the longest signal period of the leakage ringing portion. In this manner, the value of the leakage filter time can be set to be greater than the signal period of the leakage ringing portion but less than the signal period of the magnetization ringing portion. These signal periods may vary from one power converter configuration to the next, and may be determined empirically or theoretically (e.g., circuit modelling and analysis). Other examples may use different logic or otherwise be configured differently to provide similar functionality. Although leakage filter 436 provides a fixed leakage filter time in this example, it may be configured to provide an adjustable leakage filter time in other examples. For instance, the leakage filter time can be increased by configuring leakage filter 436 to selectively add more capacitance to increase the leakage filter time duration as needed to blank out leakage ringing.

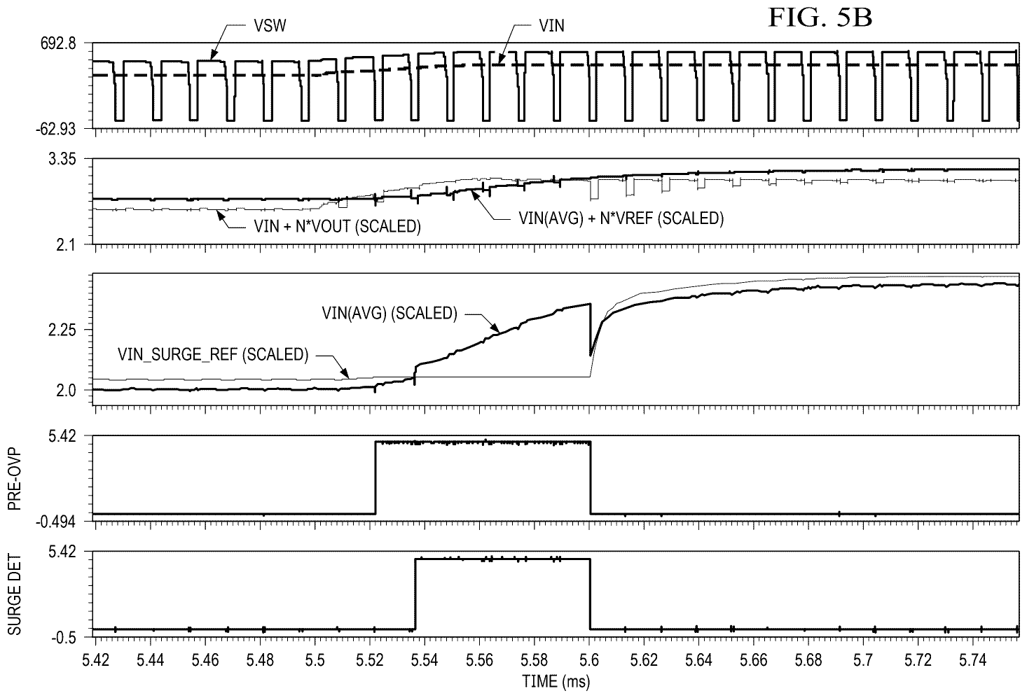

FIG. 5A illustrates plots of signals generated by the system of FIG. 1 when an OVP condition is present, in an example. Reference to FIG. 4A may be made to further facilitate understanding, and the above relevant description is equally applicable here. The first (topmost) plot of FIG. 5A is the VSW signal, from the switching node SW of a power converter, such as system 100. In this example, the VSW signal ranges between about 0 volts to about 300 volts. The second plot from top shows the output voltage VOUT of the power converter. As shown, VOUT crosses the OVP threshold (e.g., 25 volts) at around 5.801 milliseconds. The third and fourth plots from top are overlaid on each other and show the VIN+N*VOUT (scaled) voltage at the non-inverting input of comparator 420 and the VIN(AVG)+N*VREF (scaled) voltage at the inverting input of comparator 420. As shown, the VIN+N*VOUT (scaled) voltage is greater than the VIN(AVG)+N*VREF (scaled) voltage at around 5.801 milliseconds. The fifth plot from top shows the pre-OVP signal at the output of comparator 420 going high at around 5.801 milliseconds, thereby signaling a possible OVP condition. The sixth plot from top shows the OVP detect signal at the output of AND-gate 432 going high at around 5.87 milliseconds, thereby formally declaring the OVP condition. The delay from when the pre-OVP signal went high to when the OVP detect signal went high is about 69 microseconds in this example, based on delay provided by delay 422. Although not shown, the voltage scale (y-axis) of the OVP detect signal may be the same as the pre-OVP signal (e.g., about 0 volts for low state and about 5 volts for high state).

FIG. 5B illustrates plots of signals generated by the system of FIG. 1 when an input voltage surge condition is present, in an example. Reference to FIG. 4A may be made to further facilitate understanding, and the above relevant description is equally applicable here. The first and second plots from the top of FIG. 5B are overlaid on each other and show the VSW signal from the switching node SW of a power converter such as system 100, and the input voltage VIN. In this example: the VSW signal ranges between about 0 volts to about 542 volts, until a surge occurs and causes the VSW signal high level to increase to about 617 volts; and VIN ranges from about 390 volts initially and then increases to about 504 volts during the surge condition. The third and fourth plots from top are overlaid on each other and show the VIN+N*VOUT (scaled) voltage at the non-inverting input of comparator 420 and the VIN(AVG)+N*VREF (scaled) voltage at the inverting input of comparator 420. As shown, the VIN+N*VOUT (scaled) voltage is initially less than the VIN(AVG)+N*VREF (scaled) voltage, but then the surge condition commences at around 5.5 milliseconds thereby causing VIN+N*VOUT (scaled) to go greater than the VIN(AVG)+N*VREF (scaled) voltage. The fifth and sixth plots from top are overlaid on each other and show the VIN_SURGE_REF (scaled) voltage at the inverting input of comparator 430 (as provided by sample and hold 428) and the VIN(AVG) (scaled) voltage at the non-inverting input of comparator 430. The seventh plot from top shows the pre-OVP signal at the output of comparator 420 going high at around 5.522 milliseconds, thereby signaling a possible OVP condition. The eight plot from top shows the surge detect signal at the output of comparator 430 going high at around 5.537 milliseconds, thereby formally declaring an input voltage surge condition, thereby suppressing declaration of an OVP condition by operation of AND-gate 432 (and the inverted input from comparator 430). The delay from when the pre-OVP signal went high to when the surge detect signal went high is about 15 microseconds in this example, which is within the delay provided by delay 422.

### Methodology

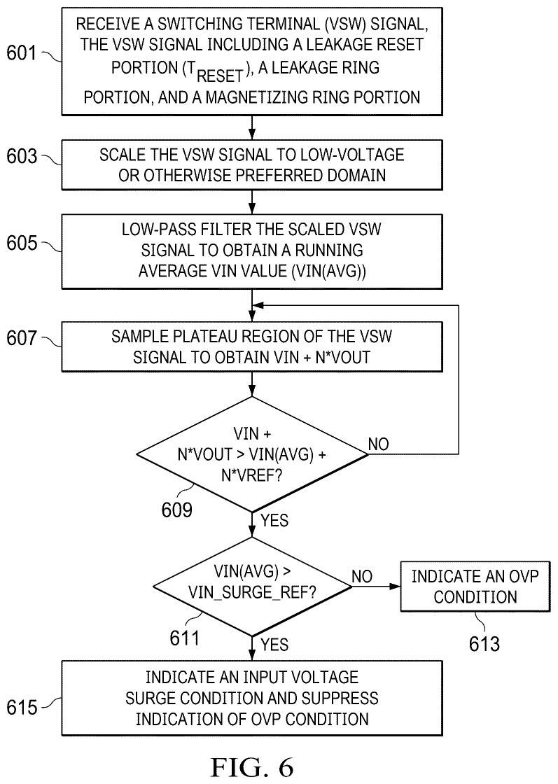

FIG. 6 illustrates a flow chart of a method for OVP in a flyback power converter, in an example. The methodology can be carried out, for example, by the system 100 shown in FIG. 1, although other systems capable of over-voltage protection using the VSW signal at the switching node of the given system may benefit from the methodology as well.

At 601, the method includes receiving a switching terminal (VSW) signal. The signal includes a leakage reset time portion (T_{RESET}), a leakage ringing portion, and a magnetizing ringing portion, such as shown in FIG. 2. In some example cases where the VSW signal is in the high-voltage domain, the method may further include, at 603, scaling the VSW signal down to a low-voltage domain. More generally, the scaling may be to convert the VSW signal from a first voltage domain or level to a second voltage domain or level in which the methodology is configured to operate. Such scaling may be carried out, for instance, by the example scaling circuit 301 described above with reference to FIGS. 3 and 4A. Any other suitable scaling circuit may be used as well.

At 605, the methodology continues with low-pass filtering the VSW signal (scaled, if applicable) to obtain a running average input voltage value VIN(AVG). Such low-pass filtering may be carried out, for instance, by the example VIN detect circuit 303 described above with reference to FIGS. 3 and 4A. Any other circuitry configured to provide the average of the VSW signal may be used as well.

At 607, the methodology continues with sampling the plateau region of the VSW signal to obtain VIN+N*VOUT. Such sampling may be carried out, for instance, by the example OVP and surge detect circuit 307 described above with reference to FIGS. 3 and 4A-C. In some such cases, the sampling may be gated by a circuit configured to detect the occurrence of the plateau portion of the VSW signal, such as the example slew detect circuit 305 described above with reference to FIGS. 3, 4A and 4D. Any other circuitry configured to sample the plateau portion of the VSW signal so that it may be compared to a reference voltage that reflects an OVP voltage limit may be used as well.

At 609, the methodology continues with determining if VIN+N*VOUT is greater than VIN(AVG)+N*VREF, to assess whether an OVP condition may be present. Such a determination can be carried out, for instance, by a comparator (such as comparator 420). If VIN+N*VOUT is not greater than VIN(AVG)+N*VREF, then no OVP condition is present and the methodology returns to the sampling at 607 to continue monitoring for a possible OVP condition. If, however, VIN+N*VOUT is greater than VIN(AVG)+N*VREF, then an OVP condition may be present and the methodology continues assessing whether the possible OVP condition may be attributable to an input surge condition.

In more detail, at 611, the methodology continues with determining if VIN(AVG) is greater than VIN_SURGE_REF (which is a sample of VIN(AVG) adjusted by a voltage to reflect a surge condition), to assess whether an input voltage surge condition may be present. Such a determination can be carried out, for instance, by a comparator (such as comparator 430). If VIN(AVG) is not greater than VIN_SURGE_REF, then no input voltage surge condition is present and the methodology continues at 613 with indicating (or declaring or confirming) the possible OVP condition is a true OVP condition. If, however, VIN (AVG) is greater than VIN_SURGE_REF, then an input voltage surge condition is present and the methodology continues at 615 with indicating an input voltage surge condition and suppressing indication of the OVP condition. Such indicating and suppressing may be carried out, for instance, by the example OVP and surge detect circuit 307, as described above with reference to FIGS. 3 and 4A-C. Any other circuitry configured to suppress indication of a possible OVP condition when an input voltage surge condition is contemporaneously present, but otherwise declare the OVP condition, may be used as well.

### Power System

FIG. 7 illustrates a block diagram of a system 700 including a flyback power converter configured for over-voltage protection without using an auxiliary winding, in an example. As shown, system 700 includes a snubber 710, a flyback transformer 711, an EMI filter 715, a rectifier 717, an AC sense circuit 718, a synchronous rectification transistor QSR, a synchronous rectification (SR) controller 720, an output capacitor COUT, an output transistor QOUT, a port 722, a feedback circuit 713 that includes USB-PD controller 724 and optocoupler 726, and a controller 728 that includes IC 101. In this example, system 700 converts an AC input voltage (VAC) to a DC input voltage (VIN) which is in turn converted by the flyback power converter to a regulated DC output voltage (VOUT). VOUT is in turn coupled to port 722 to which a load may be coupled. In other examples, the DC input voltage VIN may be sourced directly, rather than derived from AC input voltage VAC.

EMI filter 715 removes unwanted noise from the line voltage, rectifier 717 rectifies the AC input, and AC sense circuit 718 allows controller 728 to detect if VAC is present. Any suitable EMI filtering, rectifier, and sensing circuitry can be used. Other examples may have VIN directly applied rather than derived from an AC source as shown. In such cases, system 700 may not include VAC, EMI filter 115, rectifier 117, or AC sense circuit 718. Transformer 711 allows for energy storage, energy transfer, and galvanic isolation between the input VIN and output VOUT. Any suitable flyback transformer may be used. In this example, flyback transformer 111 does not include any auxiliary winding used for OVP. Other examples may include one or more auxiliary windings, for instance, to provide another option for carrying out OVP, and/or for providing valley sensing and/or a bias supply. Snubber 710 provides clamp voltage VCLAMP, and may be implemented with any suitable snubber circuit. QSR and SR controller 720 collectively provide a synchronous rectifier (instead of DOUT in FIG. 1), which can be used to improve efficiency for flyback topologies.

Capacitor COUT operates in a similar fashion as described above, with reference to FIG. 1. In this example, port 722 is a type-C USB port, and controller 724 is a USB-PD controller. Other universal and proprietary port technologies may be used. QOUT can be used, for example, to disconnect the load, responsive to control from controller 724 if an over-voltage condition or high current condition is detected. Optocoupler 726 provides feedback voltage VFB from the secondary to primary, in an isolated fashion. Controller 728 may be implemented with any suitable flyback converter control circuitry, and is further configured with IC 101, so that controller 728 is able to carry out over-voltage protection based on the VSW signal received at the SW terminal and without the use of an auxiliary winding, as variously described herein. In this example, controller 728 may further include a switching element coupled between the SW and ground terminals, and may also include a sense circuit (such as shown in FIG. 1 with respect to 109 and 108). In other examples, the switching element (and sense circuit, if present) may be implemented external to controller 728.

### FURTHER EXAMPLES

Example 1 is a circuit including: a first comparator configured to generate a first indication of an over-voltage protection (OVP) condition of a flyback power converter, using a switching terminal signal of the flyback power converter; a second comparator configured to generate a second indication of an input voltage surge condition of the flyback power converter, using the switching terminal signal of the flyback power converter; and a logic circuit configured to suppress the first indication from the first comparator, responsive to the second indication from the second comparator.

Example 2 includes the circuit of Example 1, wherein: the first comparator is configured to compare VIN+N*VOUT to VIN(AVG)+N*VREF, and indicate an OVP condition responsive to VIN+N*VOUT being greater than VIN(AVG)+N*VREF, wherein VIN corresponds to an input voltage of the flyback power converter, VIN(AVG) corresponds to a running average input voltage of the flyback power converter, N corresponds to a turns ratio of the flyback power converter, VOUT corresponds to an output voltage of the flyback power converter, and VREF corresponds to a voltage limit of the flyback power converter; and the second comparator is configured to compare VIN(AVG) to a sample of the running average input voltage adjusted by a voltage, and indicate an input voltage surge condition responsive to VIN(AVG) being greater than the sample of the running average input voltage adjusted by the voltage.

Example 3 includes the circuit of Example 2, and further includes a sample and hold circuit configured to sample the running average input voltage adjusted by the voltage, responsive to the first comparator indicating the OVP condition, and provide the sample of the running average input voltage adjusted by the voltage to an input of the second comparator.

Example 4 includes the circuit of Example 2 or 3, wherein each of the switching terminal signal, VIN+N*VOUT, VIN(AVG), and the sample of the running average input voltage adjusted by the voltage are scaled by a scaling factor.

Example 5 includes the circuit of any one of Examples 1 through 4, wherein the logic circuit has a first input coupled to an output of the first comparator, and a second input coupled to an output of the second comparator, the logic circuit configured to indicate the OVP condition responsive to signals at its first and second inputs.

Example 6 includes the circuit of Example 5, wherein the first input of the logic circuit is coupled to the output of the first comparator via a delay circuit, and the delay circuit is configured to provide a delay that is inversely proportional to input voltage of the flyback power converter.

Example 7 includes the circuit of any one of Examples 1 through 6, wherein the logic circuit includes: an inverter having an input coupled to an output of the second comparator; and an AND-gate having a first input coupled to an output of the first comparator, and a second input coupled to an output of the inverter.

Example 8 includes the circuit of any one of Examples 1 through 7, and further includes: a low-pass filter circuit configured to low-pass filter the switching terminal signal of the flyback power converter, to obtain a running average input voltage of the flyback power converter, wherein the running average input voltage is used by the first comparator to determine if the OVP condition is present and by the second comparator to determine if the input voltage surge condition is present.

Example 9 includes the circuit of Example 8, wherein low-pass filter circuit has a cut-off frequency that is proportional to input voltage of the flyback power converter.

Example 10 includes the circuit of any one of Examples 1 through 9, and further includes: a scaling circuit configured to scale the switching terminal signal of the flyback power converter by a scaling factor, to obtain a scaled version of switching terminal signal; wherein the first comparator uses the scaled version of the switching terminal signal to determine if the OVP condition is present, and the second comparator uses the scaled version of the switching terminal signal to determine if the input voltage surge condition is present.

Example 11 includes the circuit of any one of Examples 1 through 10, and further includes: a sample and hold circuit configured to sample voltage of a plateau portion of the switching terminal signal of the flyback power converter, the plateau portion between a leakage ringing portion of the switching terminal signal and a magnetizing ringing portion of the switching terminal signal, wherein the first comparator uses the sampled voltage of the plateau portion to determine if the OVP condition is present.

Example 12 includes the circuit of Example 11, and further includes a slew detect circuit configured to detect negative slew of the switching terminal signal that occurs at an end of the plateau portion of the switching terminal signal, and generate a sampling control signal responsive to detected negative slew; wherein the sample and hold circuit samples the voltage of the plateau portion responsive to the sampling control signal.

Example 13 includes the circuit of Example 11 or 12, wherein the sampled voltage of the plateau portion corresponds to VIN+N*VOUT, wherein VIN corresponds to an input voltage of the flyback power converter, N corresponds to a turns ratio of the flyback power converter, and VOUT corresponds to an output voltage of the flyback power converter.

Example 14 is a circuit, comprising: a first circuit configured to scale a switching terminal signal of a flyback power converter by a scaling factor, so as to generate a scaled version of the switching terminal signal; a second circuit configured to determine a running average input voltage of the flyback power converter based on the scaled version of the switching terminal signal; and a third circuit configured to use the running average input voltage to determine if both an over-voltage protection (OVP) condition and an input voltage surge condition are present in the flyback power converter, and suppress an indication of the OVP condition responsive to the input voltage surge condition being present.

Example 15 includes the circuit of Example 14, wherein the third circuit includes: a first comparator configured to indicate the OVP condition; a second comparator configured to indicate the input voltage surge condition; and a logic circuit configured to suppress indication of the OVP condition by the first comparator, responsive to indication of the input voltage surge condition by the second comparator.

Example 16 includes the circuit of Example 15, wherein a first input of the logic circuit is coupled to an output of the first comparator via a delay circuit, and the delay circuit is configured to provide a delay that is inversely proportional to input voltage of the flyback power converter, and a second input of the logic circuit is coupled to an output of the second comparator via an inverter.

Example 17 includes the circuit of Example 14 or 15, wherein the third circuit includes: a sample and hold circuit configured to sample voltage of a plateau portion of the switching terminal signal of the flyback power converter, the plateau portion between a leakage ringing portion of the switching terminal signal and a magnetizing ringing portion of the switching terminal signal, wherein the first comparator uses the sampled voltage of the plateau portion to determine if the OVP condition is present.

Example 18 includes the circuit of Example 17, and further includes a fourth circuit configured to detect negative slew of the switching terminal signal that occurs at an end of the plateau portion of the switching terminal signal, and generate a sampling control signal responsive to detected negative slew; wherein sampling carried out by the sample and hold circuit is gated by the sampling control signal.

Example 19 is a method, comprising: comparing VIN+N*VOUT to VIN(AVG)+N*VREF, wherein VIN corresponds to an input voltage of a flyback power converter, VIN(AVG) corresponds to a running average input voltage of the flyback power converter, N corresponds to a turns ratio of the flyback power converter, VOUT corresponds to an output voltage of the flyback power converter, and VREF corresponds to a voltage limit of the flyback power converter; and responsive to VIN+N*VOUT being greater than VIN(AVG)+N*VREF, comparing VIN(AVG) to a sample of the running average input voltage adjusted by a voltage; responsive to VIN(AVG) being greater than the sample of the running average input voltage adjusted by the voltage, indicating an input voltage surge condition; and responsive to VIN(AVG) not being greater than the sample of the running average input voltage adjusted by the voltage, indicating an over-voltage protection condition.

Example 20 includes the method of Example 19, wherein: responsive to VIN+N*VOUT not be being greater than VIN(AVG)+N*VREF, the method includes not indicating the over-voltage protection condition, not indicating the input voltage surge condition, and continue monitoring for the over-voltage condition and the input voltage surge condition; and responsive to VIN(AVG) being greater than the sample of the running average input voltage adjusted by the voltage, the method includes suppressing indication of the over-voltage condition.

Example 21 includes the method of Example 19 or 20, and further includes: receiving a switching terminal signal of the flyback power converter, the switching terminal signal including a leakage reset portion, a leakage ringing portion, and a magnetizing ringing portion; low-pass filtering the switching terminal signal to obtain VIN(AVG); and sampling voltage of the switching terminal signal between the leakage ringing portion and the magnetizing ringing portion to obtain

$$VIN + N * VOUT .$$

Example 22 includes the method of Example 21, wherein prior to comparing VIN+N*VOUT to VIN(AVG)+N*VREF, the method includes scaling the switching terminal signal by a scaling factor, and wherein each of VIN+N*VOUT, VIN(AVG), and the sample of the running average input voltage adjusted by the voltage are scaled by the scaling factor.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs), to name a few examples.

References herein to a field effect transistor (FET) being “on” means that the conduction channel of the FET is present and drain current may flow through the FET. References herein to a FET being “off” means that the conduction channel is not present and drain current does not flow through the FET. A FET that is off, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. In another example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described embodiments, and other embodiments are possible, within the scope of the claims.

What is claimed is:

1. A circuit, comprising:
a first comparator configured to generate a first indication of an over-voltage protection (OVP) condition of a flyback power converter, using a switching terminal signal of the flyback power converter;
a second comparator configured to generate a second indication of an input voltage surge condition of the flyback power converter, using the switching terminal signal of the flyback power converter; and
a logic circuit configured to suppress the first indication from the first comparator, responsive to the second indication from the second comparator.

2. The circuit of claim 1, wherein:
the first comparator is configured to
compare VIN+N*VOUT to VIN(AVG)+N*VREF, and
indicate an OVP condition responsive to VIN+N*VOUT being greater than VIN(AVG)+N*VREF,
wherein VIN corresponds to an input voltage of the flyback power converter, VIN(AVG) corresponds to a running average input voltage of the flyback power converter, N corresponds to a turns ratio of the flyback power converter, VOUT corresponds to an output voltage of the flyback power converter, and VREF corresponds to a voltage limit of the flyback power converter; and
the second comparator is configured to
compare VIN(AVG) to a sample of the running average input voltage adjusted by a voltage, and
indicate an input voltage surge condition responsive to VIN(AVG) being greater than the sample of the running average input voltage adjusted by the voltage.

3. The circuit of claim 2, comprising a sample and hold circuit configured to sample the running average input voltage adjusted by the voltage, responsive to the first comparator indicating the OVP condition, and provide the sample of the running average input voltage adjusted by the voltage to an input of the second comparator.

4. The circuit of claim 2, wherein each of the switching terminal signal, VIN+N*VOUT, VIN(AVG), and the sample of the running average input voltage adjusted by the voltage are scaled by a scaling factor.

5. The circuit of claim 1, wherein the logic circuit has a first input coupled to an output of the first comparator, and a second input coupled to an output of the second comparator, the logic circuit configured to indicate the OVP condition responsive to signals at its first and second inputs.

6. The circuit of claim 5, wherein the first input of the logic circuit is coupled to the output of the first comparator via a delay circuit, and the delay circuit is configured to provide a delay that is inversely proportional to input voltage of the flyback power converter.

7. The circuit of claim 1, wherein the logic circuit includes:
an inverter having an input coupled to an output of the second comparator; and
an AND-gate having a first input coupled to an output of the first comparator, and a second input coupled to an output of the inverter.

8. The circuit of claim 1, comprising:
a low-pass filter circuit configured to low-pass filter the switching terminal signal of the flyback power converter, to obtain a running average input voltage of the flyback power converter, wherein the running average input voltage is used by the first comparator to determine if the OVP condition is present and by the second comparator to determine if the input voltage surge condition is present.

9. The circuit of claim 8, wherein low-pass filter circuit has a cut-off frequency that is proportional to input voltage of the flyback power converter.

10. The circuit of claim 1, comprising:
a scaling circuit configured to scale the switching terminal signal of the flyback power converter by a scaling factor, to obtain a scaled version of switching terminal signal;
wherein the first comparator uses the scaled version of the switching terminal signal to determine if the OVP condition is present, and the second comparator uses the scaled version of the switching terminal signal to determine if the input voltage surge condition is present.

11. The circuit of claim 1, comprising:
a sample and hold circuit configured to sample voltage of a plateau portion of the switching terminal signal of the flyback power converter, the plateau portion between a leakage ringing portion of the switching terminal signal and a magnetizing ringing portion of the switching terminal signal, wherein the first comparator uses the sampled voltage of the plateau portion to determine if the OVP condition is present.

12. The circuit of claim 11, comprising:
a slew detect circuit configured to detect negative slew of the switching terminal signal that occurs at an end of the plateau portion of the switching terminal signal, and generate a sampling control signal responsive to detected negative slew;
wherein the sample and hold circuit samples the voltage of the plateau portion responsive to the sampling control signal.

13. The circuit of claim 11, wherein the sampled voltage of the plateau portion corresponds to VIN+N*VOUT, wherein VIN corresponds to an input voltage of the flyback power converter, N corresponds to a turns ratio of the flyback power converter, and VOUT corresponds to an output voltage of the flyback power converter.

14. A circuit, comprising:
a first circuit configured to scale a switching terminal signal of a flyback power converter by a scaling factor, so as to generate a scaled version of the switching terminal signal;
a second circuit configured to determine a running average input voltage of the flyback power converter based on the scaled version of the switching terminal signal; and
a third circuit configured to use the running average input voltage to determine if both an over-voltage protection (OVP) condition and an input voltage surge condition are present in the flyback power converter, and suppress an indication of the OVP condition responsive to the input voltage surge condition being present.

15. The circuit of claim 14, wherein the third circuit includes:
a first comparator configured to indicate the OVP condition;
a second comparator configured to indicate the input voltage surge condition; and
a logic circuit configured to suppress indication of the OVP condition by the first comparator, responsive to indication of the input voltage surge condition by the second comparator.

16. The circuit of claim 15, wherein a first input of the logic circuit is coupled to an output of the first comparator via a delay circuit, and the delay circuit is configured to provide a delay that is inversely proportional to input voltage of the flyback power converter, and a second input of the logic circuit is coupled to an output of the second comparator via an inverter.

17. The circuit of claim 15, wherein the third circuit includes:
a sample and hold circuit configured to sample voltage of a plateau portion of the switching terminal signal of the flyback power converter, the plateau portion between a leakage ringing portion of the switching terminal signal and a magnetizing ringing portion of the switching terminal signal, wherein the first comparator uses the sampled voltage of the plateau portion to determine if the OVP condition is present.

18. The circuit of claim 17, comprising:
a fourth circuit configured to detect negative slew of the switching terminal signal that occurs at an end of the plateau portion of the switching terminal signal, and generate a sampling control signal responsive to detected negative slew;
wherein sampling carried out by the sample and hold circuit is gated by the sampling control signal.

19. A method, comprising:
comparing VIN+N*VOUT to VIN(AVG)+N*VREF, wherein VIN corresponds to an input voltage of a flyback power converter, VIN(AVG) corresponds to a running average input voltage of the flyback power converter, N corresponds to a turns ratio of the flyback power converter, VOUT corresponds to an output voltage of the flyback power converter, and VREF corresponds to a voltage limit of the flyback power converter; and
responsive to VIN+N*VOUT being greater than VIN(AVG)+N*VREF,
comparing VIN(AVG) to a sample of the running average input voltage adjusted by a voltage;
responsive to VIN(AVG) being greater than the sample of the running average input voltage adjusted by the voltage, indicating an input voltage surge condition; and
responsive to VIN(AVG) not being greater than the sample of the running average input voltage adjusted by the voltage, indicating an over-voltage protection condition.

20. The method of claim 19, wherein:
responsive to VIN+N*VOUT not be being greater than VIN(AVG)+N*VREF, the method includes
not indicating the over-voltage protection condition,
not indicating the input voltage surge condition, and
continue monitoring for the over-voltage condition and the input voltage surge condition; and
responsive to VIN(AVG) being greater than the sample of the running average input voltage adjusted by the voltage, the method includes
suppressing indication of the over-voltage condition.

21. The method of claim 19, comprising:
receiving a switching terminal signal of the flyback power converter, the switching terminal signal including a leakage reset portion, a leakage ringing portion, and a magnetizing ringing portion;
low-pass filtering the switching terminal signal to obtain VIN(AVG); and
sampling voltage of the switching terminal signal between the leakage ringing portion and the magnetizing ringing portion to obtain VIN+N*VOUT.

22. The method of claim 21, wherein prior to comparing VIN+N*VOUT to VIN(AVG)+N*VREF, the method includes scaling the switching terminal signal by a scaling factor, and wherein each of VIN+N*VOUT, VIN(AVG), and the sample of the running average input voltage adjusted by the voltage are scaled by the scaling factor.
